(19) United States
(12) Patent Application Publication
(10) Pub. No.: US 2018/0036692 A1
(43) Pub. Date: Feb. 8, 2018

(54) MANURE AGITATION VESSEL WITH REMOTE POWER SOURCE

(71) Applicant: 1863385 Ontario Inc., Tavistock (CA)

(72) Inventor: Larry BEARINGER, Tavistock (CA)

(21) Appl. No.: 15/656,090

(22) Filed: Jul. 21, 2017

Related U.S. Application Data
(60) Provisional application No. 62/370,760, filed on Aug. 4, 2016.

(51) Int. Cl. B01F 5/02; B01F 15/02; B01F 15/00; B01F 13/00

(52) U.S. Cl. CPC B01F 5/0225; B01F 13/0049; B01F 15/0243; B01F 15/00305

(57) ABSTRACT

A system for agitating manure includes a vessel shaped to be placed in a manure storage installation. The vessel includes a vessel frame having floatation for providing floatation to the vessel, at least one outlet nozzle attached to the vessel frame for agitating the manure, and a control system attached to the vessel frame for controlling the direction of the at least one outlet nozzle. The system includes a land based power source separated from the vessel having a fluid pump for pumping fluid from a land based input nozzle to supply fluid to the at least one outlet nozzle on the vessel. The system includes a fluid conduit connecting the land based power source to the at least one outlet nozzle and a remote control for user control of the control system of the vessel.

### CROSS REFERENCE TO RELATED APPLICATION

This application claims the benefit of U.S. Provisional Patent Application No. 62/370,760, filed Aug. 4, 2016, which is hereby incorporated by reference.

### TECHNICAL FIELD

The embodiments disclosed herein relate to apparatus for agitating manure stored in reservoirs and, more particularly, to vessels having manure agitating apparatus adapted for use in earthen storage reservoirs, such as manure holding ponds, lagoons, and settling basins.

### INTRODUCTION

Manure from livestock is an excellent source of fertilizer containing nitrogen, phosphorous and other nutrients desirable for enrichment of soil. Manure is also an important source of organic matter which, when added to soil, helps to improve soil composition, aeration, water infiltration and moisture-retention capability. Livestock produce a large amount of manure. Manure is in constant supply and a means of storage and preservation is therefore required.

For this reason, earthen storage installations in the nature of holding ponds, lagoons and settling basins have been developed and successfully utilized for the storage of large quantities of manure. Manure from a livestock operation is pumped into a lagoon where anaerobic bacteria digest, liquefy, and convert a portion of the manure to carbon dioxide, methane, ammonia and hydrogen sulfide. The resulting supernatant contains nitrogen and calcium. The resulting solids form a sludge that rests on the bottom of the manure lagoon.

If the sludge layer is not periodically agitated and removed, it will eventually decrease the available volume of the storage installation area, thus leading to increased risk of overflows, economic, and environmental concerns, etc. To prevent an undesirable buildup of sludge the manure is agitated into suspension within the supernatant.

High-volume pressure pumps are typically used as agitators for manure ponds and lagoons. These pumps use the force of moving water to dislodge and mix the bottom sludge with other floating matter. While conventional agitators work reasonably well for their intended purpose, there are drawbacks.

Conventional methods of agitating the manure include attaching a shaft with a propeller or auger to the power takeoff of a tractor or other farm vehicle resting on the shore. The rotating propeller or auger forces the supernatant down into the sludge, causing the solids within the sludge to move upward into suspension within the supernatant in only a narrow area proximate to the tractor on the shore.

In response, floating vehicles have been developed to mix sludge at the center of the lagoon. These conventional vehicles may be equipped with a fluid intake, a supernatant pump, and a fluid nozzle to draw supernatant into the pump and force the supernatant at high speed downward toward the sludge. The conventional floating agitation vehicles may include heavy onboard engines and pumps, which may impact the flotation and maneuverability of the vehicle. Further, maneuvering the floating agitator in and out of a manure pond or lagoon can also pose a significant challenge.

In some cases, foreign material may be present in the storage installation. The storage installation may have open tops that are exposed to the atmosphere where blowing wind may blow material such as plastic, burlap bags, and wood from daily operations on the farm into the storage installation. Another troublesome material found in the storage installation is the afterbirth from cows giving birth. The presence of these materials in the storage installation may cause the onboard pump to plug up. When this happens, propulsion and steering on the conventional system is lost as the vessel depends on the onboard pump and engine to propel the vehicle and ultimately the vehicle is stranded in the lagoon. To fix, an operator boards the vessel and attempts to repair the onboard pump and engine. This practice exposes personnel to harmful gasses (such as carbon dioxide, methane, ammonia, and hydrogen sulfide) that are associated with manure agitation.

Therefore, it is evident there is a substantial and unsatisfied need in the agricultural industry for a reliable and cost-effective solution to the drawbacks associated with conventional floating manure agitators.

### SUMMARY

According to some embodiments, there is provided a system for agitating manure. The system includes a vessel shaped to be placed in a manure storage installation, a land based power source separated from the vessel, and a remote control for user control of the control system of the vessel. The vessel includes a vessel frame having floatation for providing floatation to the vessel, at least one outlet nozzle attached to the vessel frame for agitating the manure, and a control system attached to the vessel frame for controlling the direction of the at least one outlet nozzle. The land based power source includes a fluid pump for pumping fluid from a land based input nozzle to supply fluid to the at least one outlet nozzle on the vessel, and a fluid supply conduit connecting the land based power source to the at least one outlet nozzle.

The land based power source may further include a prime mover for providing power to the fluid pump, a fuel tank for storing fuel for the power source, and a pump control for controlling the fluid pump and the power source.

The prime mover may be exchangeable based on the power needs of the fluid pump without modifying the vessel.

The land based input nozzle may pump liquid that is located proximate to the land based power source and remote from the vessel.

The at least one outlet nozzle may provide movement to the vessel and the at least one outlet nozzle steers the direction of the vessel.

The control system may include a hydraulic pump attached to the vessel frame for providing hydraulic fluid to a hydraulic actuator and an onboard small engine attached to the vessel frame for providing power to the hydraulic pump. The hydraulic actuators may be attached to the at least one outlet nozzles and manipulate the direction of the at least one outlet nozzles.

The control system may further include a hydraulic fluid reservoir attached to the vessel frame for storing the hydraulic fluid and a fuel tank attached to the vessel frame for storing a fuel supply for the onboard small engine.

The remote control may be operable to control the land based power source. The remote control may provide control instructions to the control system to control the direction of the outlet nozzles. The remote may include a remote transceiver for sending nozzle direction instructions to the control system and control inputs for receiving the nozzle direction instructions from a user. The control inputs may include a set up mode and a run mode.

According to some embodiments, there is provided a vessel shaped to be placed in a manure storage installation. The vessel includes a vessel frame having floatation for providing floatation to the vessel, at least one outlet nozzle attached to the vessel frame for agitating the manure, wherein the at least one outlet nozzle receives fluid from a land based power source via a fluid supply conduit, wherein the land based power source is separated from the vessel, and a control system attached to the vessel frame for controlling the direction of the at least one outlet nozzle, and wherein the control system receives control instructions from a remote control.

The land based power source may not be an integral part of the manure agitation vessel.

The manure agitation vessel may further include at least one outrigger attached to the vessel frame on either side of the manure agitation vessel to provide further stability to the manure agitation vessel. The at least one outrigger may be hydraulically actuated by an outrigger hydraulic actuator that is controlled by the control system. The outrigger hydraulic actuator hydraulically raises the at least one outrigger for transport and lowers the at least one outrigger when in use. The at least one outrigger may further include an outrigger frame for holding additional floatation. The outrigger frame is attached to the vessel frame by an outrigger arm at an outrigger hinge.

The at least one nozzle may include two nozzles, each positioned at either end of the vessel.

The manure agitation vessel may further include a downrigger attached to the vessel frame for articulating to engage with solid manure or the bottom of a storage installation.

The control system may include a hydraulic pump attached to the vessel frame for providing hydraulic fluid to a hydraulic actuator and an onboard small engine attached to the vessel frame for providing power to the hydraulic pump. The hydraulic actuators are attached to the at least one outlet nozzles and manipulate the direction of the at least one outlet nozzles.

The control system may further include a hydraulic fluid reservoir attached to the vessel frame for storing the hydraulic fluid and a fuel tank attached to the vessel frame for storing a fuel supply for the onboard small engine.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a block diagram of a manure agitation system, in accordance with an embodiment;

FIG. 2 is a perspective view of a manure agitation vessel, in accordance with an embodiment;

FIG. 3 is a front view of the manure agitation vessel of FIG. 2;

FIG. 4 is a side view of the manure agitation vessel of FIG. 2, in a transport position;

FIG. 5 is a top view of the manure agitation vessel of FIG. 2, in a transport position;

FIG. 6 is a front view of the manure agitation vessel of FIG. 2, in a transport position; and

FIG. 7 is a perspective view of a manure agitation vessel, in accordance with a further embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below. It is possible that an apparatus or process described below is not covered by any of the claimed embodiments.

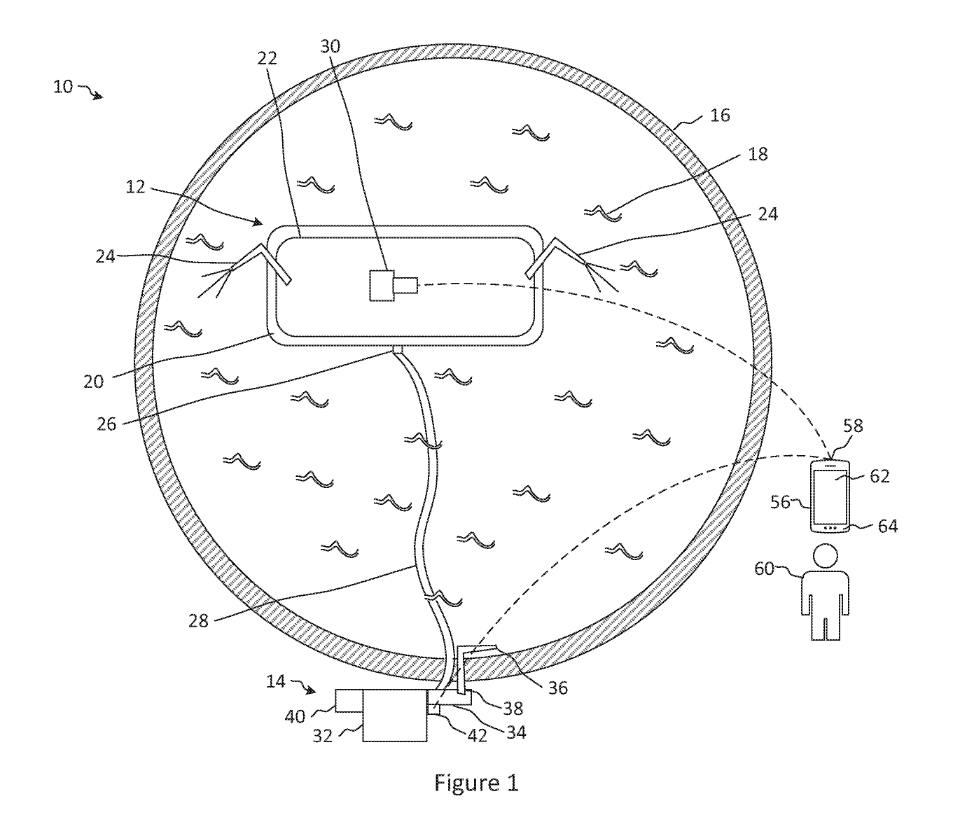

Referring to FIG. 1, illustrated therein is a manure agitation system 10, in accordance with an embodiment. The manure agitation system 10 includes a manure agitation vessel 12 and a remote or land based power source 14 for providing pumped fluid to the manure agitation vessel 12.

The manure agitation vessel 12 is sized and shaped to be placed in a manure reservoir or storage installation 16 such as a holding pond, a lagoon, or a settling basin. The storage installation 16 stores quantities of manure 18. The manure 18 may be from, for example, a livestock operation where anaerobic bacteria digest, liquefy, and convert a portion of the manure 18 to carbon dioxide, methane, ammonia and hydrogen sulfide. The resulting supernatant contains nitrogen and calcium. The manure 18 includes solids that form a sludge that rest on the bottom of the storage installation 16. The manure agitation vessel 12 mixes and agitates the settled solid and liquid manure 18. The mixed manure 18 may be pumped onto fields as fertilizer.

The manure agitation system 10 has at least two separated components: the manure agitation vessel 12 and the land based power source 14, which is separated from the vessel 12. When the manure agitation vessel 12 is in use and located in the storage installation 16, the land based power source 14 is remotely located on land distant from the manure agitation vessel 12. For example, the land based power source 14 is located at the side of the storage installation 16, while the manure agitation vessel 12 is located in the storage installation.

The manure agitation vessel 12 has a vessel frame 20, floatation 22, and one or more outlet nozzles 24 that spray liquid out into the manure 18 so that the solid and liquid mix. The vessel frame 20 holds the components of the manure agitation vessel 12 together. The floatation 22, such as a buoyancy tank, is attached to the vessel frame 20 and provides floatation to the manure agitation vessel 12.

The manure agitation vessel 12 includes at least one outlet nozzle 24 attached to the vessel frame 20. The outlet nozzle 24 sprays fluid to agitate and mix the manure 18. The direction of the outlet nozzles 24 are controlled by a control system 30, such as a hydraulic control system, attached to the vessel frame 20. The outlet nozzle 24 receives fluid from an inlet nozzle 26 on the manure agitation vessel 12. The inlet nozzle 26 is connected via a fluid supply conduit 28, such as a hose, to the land based power source 14. The fluid supply conduit 28 pumps liquid that is located proximate to the land based power source 14 and that is remote from the manure agitation vessel 12.

The land based power source 14 includes a prime mover 32 such as a high power engine for providing power to a fluid pump 34. The prime mover 32 can be exchanged based on the power needs of the fluid pump 34 without modifying the manure agitation vessel 12. The fluid pump 34 pumps the fluid from the storage installation 16 via an intake conduit 36 through a land based input nozzle 38 to supply manure 18 to the fluid supply conduit 28. The fluid supply conduit 28 provides fluid from the on land fluid pump 34 to the outlet nozzles 24 onboard the manure agitation vessel 12.

The land based power source 14 also includes a fuel tank 40 for storing fuel for the prime mover 32. The land based power source 14 also includes a pump control 42 for controlling the fluid pump 34 and the prime mover 32. In an embodiment, the pump control 42 is a simple on/off mechanism or switch. In a further embodiment, the pump control 42 is remotely controlled by a remote control 56.

The remote control 56 includes a remote transceiver 58 that sends (and receives) nozzle direction instructions to a vessel transceiver on the manure agitation vessel 12. The user 60 inputs the nozzle direction instructions into the remote control 56 using control inputs 62 (such as buttons, touchscreen, or other input devices, as is known in the art). The control inputs 62 receive the user instructions and a processor 64 such as a programmable logic controller (PLC) processes the nozzle direction instructions for transmission by the remote transceiver 58. The remote control 56 may also control the land based power source 14, including the prime mover 32.

In an embodiment, the control inputs 62 include a set up mode for setting up operation of the manure agitation vessel 12 and a run mode for use during operation of the manure agitation vessel 12. The PLC enables the set up mode and the working mode. This allows for greater function control with the remote control 56.

The control inputs 62 may also include an engine stop button, a start button, a throttle down button, and a throttle up button to steer the manure agitation vessel 12 floating in the storage installation 16.

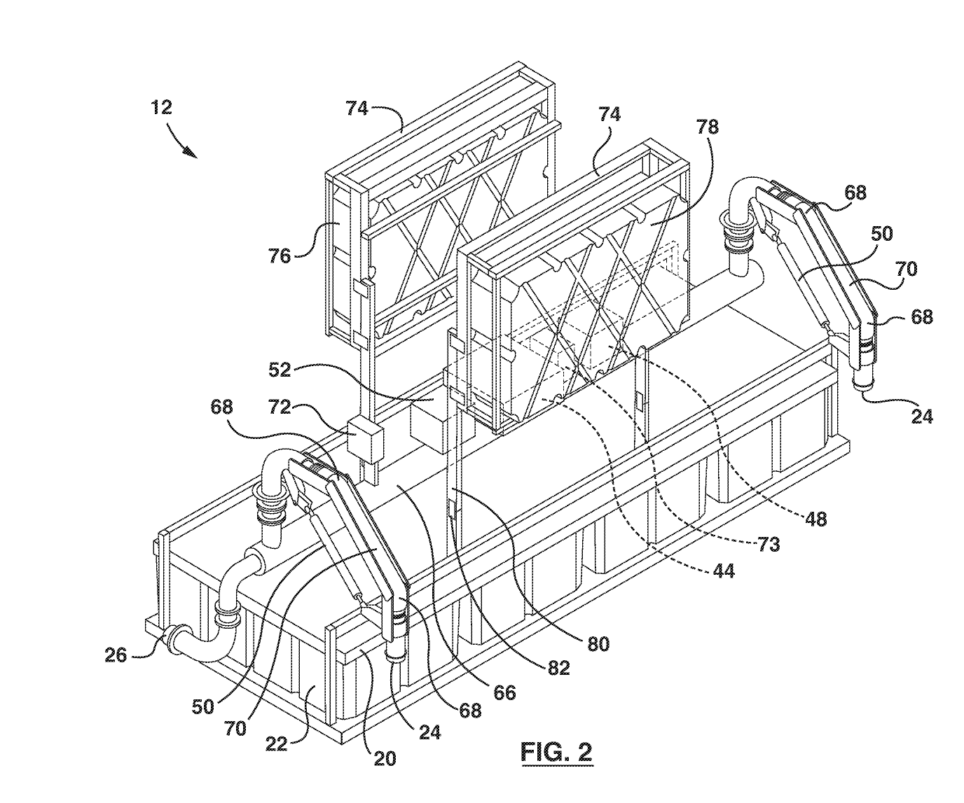

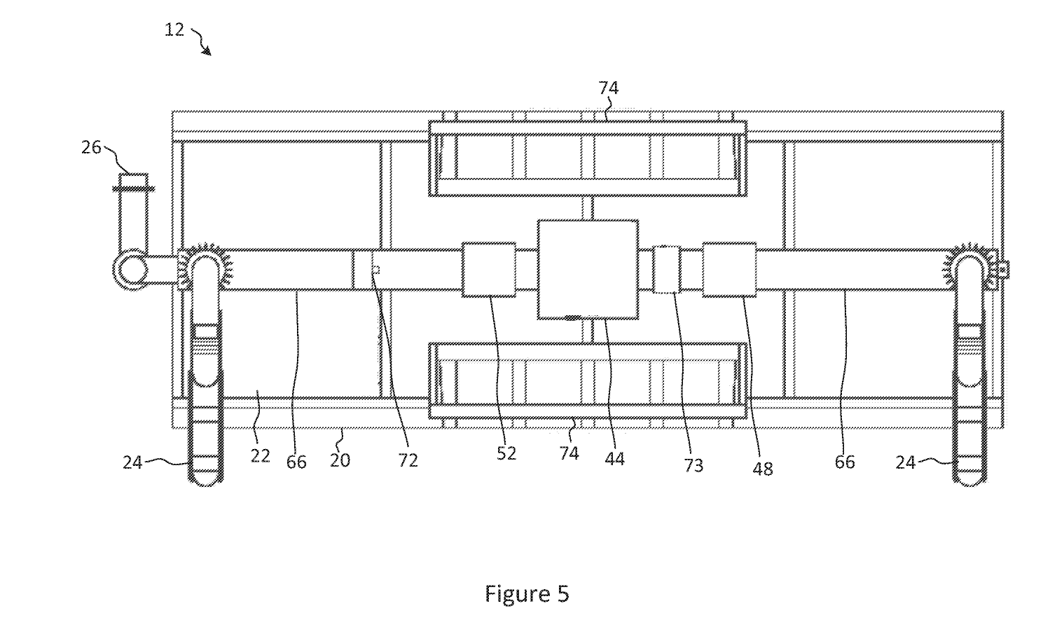

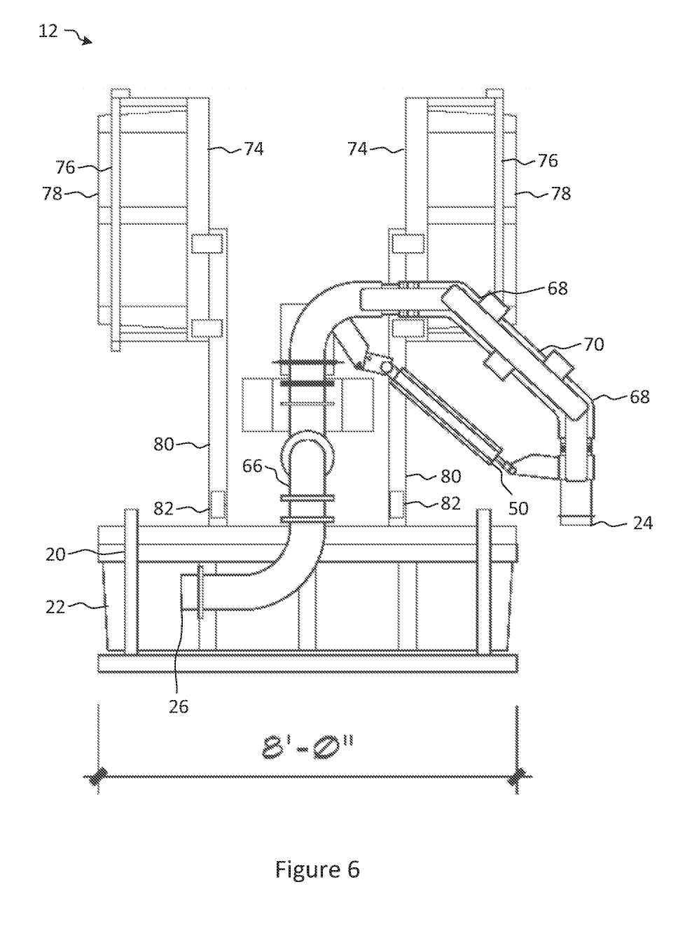

Turning now to FIGS. 2 to 6, illustrated therein is a manure agitation vessel 12, in accordance with an embodiment. The manure agitation vessel 12 includes two outlet nozzles 24, each positioned at either end of the manure agitation vessel 12 with piping 66 connecting the two outlet nozzles 24. The outlet nozzles 24 are mounted on the upper surface of the manure agitation vessel 12, each of the outlet nozzles 24 being configured for directional movement beyond outer confines of the manure agitation vessel 12 and about multiple axes relative to the manure agitation vessel 12. The outlet nozzles 24 are readily viewable above the upper surface of the deck for ease of managing agitation of the manure 18 and directional control of the manure agitation vessel 12.

The outlet nozzle 24 provides movement to the manure agitation vessel 12. In an embodiment, the outlet nozzles 24 can be directed to steer the direction of the manure agitation vessel 12. The outlet nozzle 24 has hydraulic actuators 50 to manipulate the direction of the outlet nozzle 24. For example, the hydraulic actuators 50 may be hydraulic cylinders. The manure agitation vessel 12 includes the control system 30 for controlling the hydraulic actuators 50 and therefore the direction of the outlet nozzle 24. The hydraulically controlled actuators 50 are connected to each of said outlet nozzles 24 for controlling movement thereof about each of said multiple axes.

The outlet nozzle 24 includes at least one pivot 68 having a simple, rugged design to give maximum range of operation and longevity. The outlet nozzle 24 is positioned on a two stage nozzle arm 70 to provide an increased range and flexibility than the hydraulic actuator 50 with a limited stroke. Further, the two stage nozzle arm 70 may be in a visible location at all times, above the manure 18. Having the two stage nozzle arm 70 above the manure 18 may avoid plugging issues, may improve safety, may reduce harmful gasses, and may be easier to unplug. In an embodiment, the outlet nozzles 24 are high pressure jet nozzles that are fully visible and capable of movement in multiple directions. The outlet nozzles 24 are angled to develop vortices of supernatant into the solids to further mix the manure 18 into a slurry.

For maximum versatility and reach, each outlet nozzle 24 is constructed for multi-axis rotational movement, capable of substantially 180 degree rotation about a generally vertical axis and vertical pivotal movement of more than 90 degrees about a horizontal axis. The outlet nozzles 24 are mounted atop the vessel deck and constructed and arranged for multi-axis pivotal movement. This facilitates maximum versatility and reach for agitating the manure 18, and for maintaining directional control of the manure agitation vessel 12. For optimum mobility, each outlet nozzle 24 is equipped with separate hydraulic actuators 50 to cause movement about multiple axes. Consequently, with the enhanced mobility of outlet nozzles 24, the user 60 may effectively agitate the manure 18 and simultaneously maintain accurate and easy directional control of the manure agitation vessel 12 solely through the thrust of the readily visible above-surface high pressure jet outlet nozzles 24.

In an embodiment, the outlet nozzle 24 can rotate from 60 degrees aft and 60 degrees stern, and most preferably at least about 45 degrees aft and 45 degrees stern.

The outlet nozzles 24 are controlled by the control system 30 on the manure agitation vessel 12. The control system 30 includes an onboard small engine 44 attached to the vessel frame 20 for providing power to a hydraulic pump 46. The hydraulic pump 46 is attached to the vessel frame 20 and pumps hydraulic fluid such as hydraulic oil from a hydraulic fluid reservoir 48 to the hydraulic actuators 50 on the outlet nozzle 24. The control system 30 may also include a small fuel tank 52 or battery 73 for storing a fuel supply for the onboard small engine 44.

The onboard small engine 44 may be considerably smaller (for example, 50 times smaller) than the land based prime mover 32. For example, the onboard engine 44 may provide 10 to 15 horsepower and weigh between 50 to 60 pounds, with the fuel tank holding 2-5 gallons of gas. The land based prime mover 32 may provide 200 horsepower and weigh 2500 pounds, with the land based fuel tank 40 holding 150-250 gallons and weighing 2000 pounds. The land based fuel tank 40 will decrease in weight as fuel is used and where the fuel tank 40 is on the vessel 12, the ballast weight of the vessel 12 would be impacted and affect the buoyancy and balance of the vessel 12. By locating the prime mover 32 and land based fuel tank 40 off of the vessel 12, the buoyancy and stability of the vessel 12 may be improved.

The onboard small engine 44 may be a 13 horsepower (HP) Honda gas engine that operates the hydraulic pump 46 on the manure agitation vessel 12. The hydraulic pump 46 controls the hydraulic actuators 50 that direct the plurality of outlet nozzles 24. The remote control 56 is used to activate the onboard small engine 44 and to guide the manure agitation vessel 12. The direction of the outlet nozzles 24 may be controlled by the remote control 56 to agitate the manure 18 and to steer the manure agitation vessel 12.

The control system 30 includes a control panel 72 that communicates with the remote control 56 (shown schematically in FIG. 1). The remote control 56 provides control instructions to the control panel 72 to control the direction of the outlet nozzles 24. The control panel 72 includes the vessel transceiver powered by a battery 73, that allows the control panel 72 to operate wirelessly with the remote control 56.

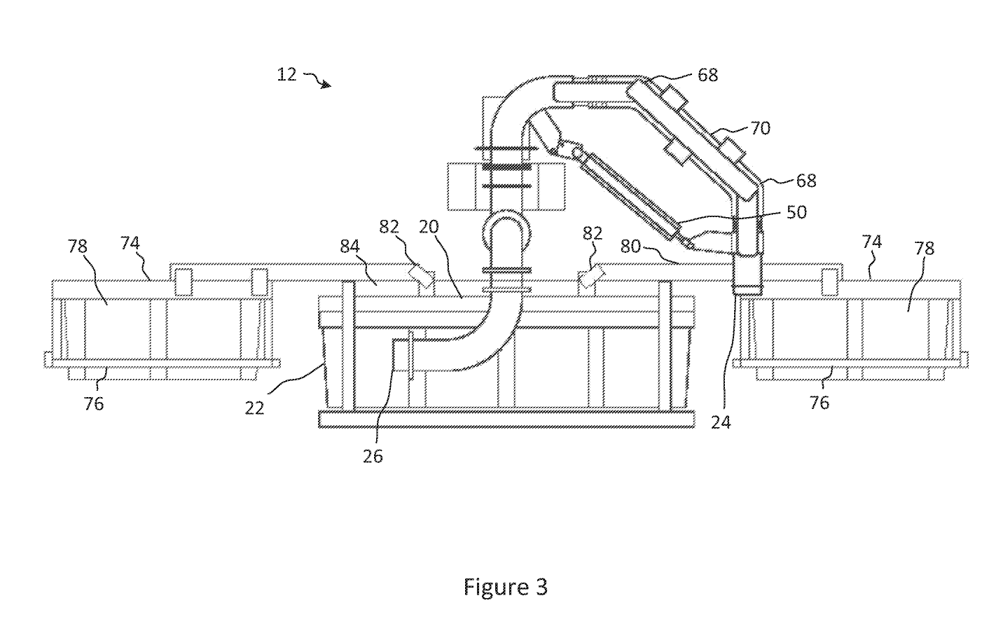

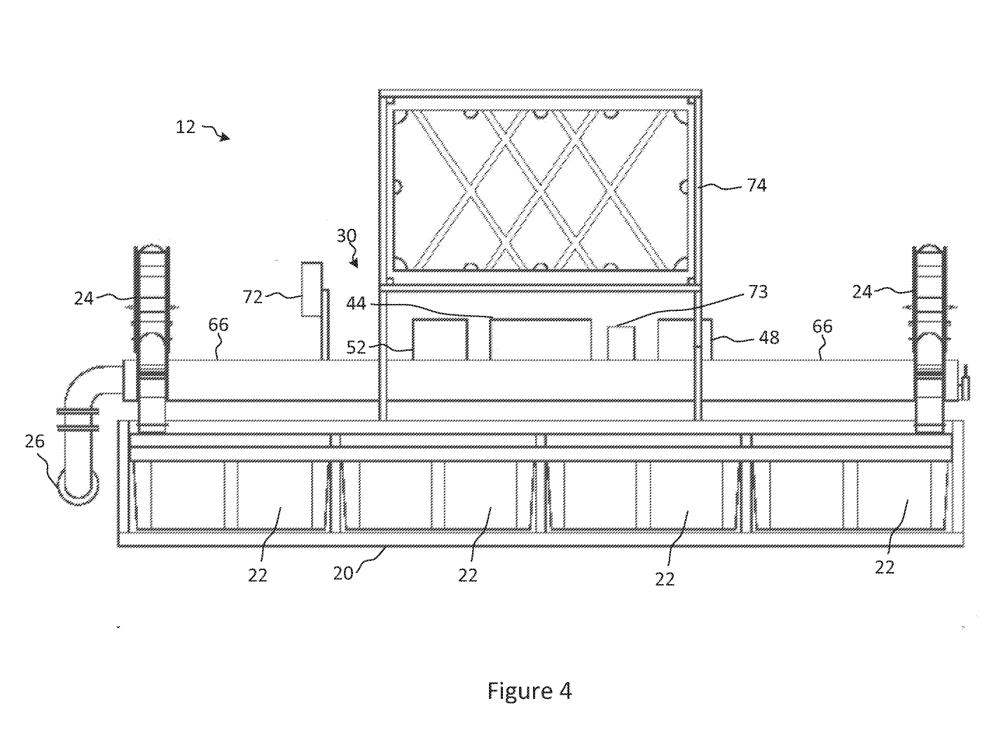

In an embodiment, the manure agitation vessel 12 includes at least one outrigger 74 on either side of the manure agitation vessel 12 to provide further stability. The outrigger 74 can be hydraulically raised (FIGS. 4-6) when not in use and in transport and lowered (FIG. 3) when in use. The outrigger 74 includes an outrigger frame 76 holding additional flotation 78. The outrigger frame 76 is attached to the vessel frame 20 by an outrigger arm 80 at an outrigger hinge 82. The outrigger arm 80 and outrigger hinge 82 are hydraulically actuated by an outrigger hydraulic actuator 84 that is controlled by the control system 30 and the remote control 56. The outrigger hydraulic actuator 84 hydraulically raises the at least one outrigger 74 for transport and lowers the at least one outrigger 74 when in use

The outriggers 74 may fold up to a transport position to meet width and height requirements of transport regulations (e.g. department of transport (DOT)), for ease in road travel and passage through tight areas, such as gates, or for improved storage. When in the storage installation 16, the outriggers 74 fold down to give stability and maneuverability to the manure agitation vessel 12. In certain cases, the outriggers 74 are not necessary for buoyancy of the manure agitation vessel 12 but rather provide stability.

In an embodiment, the manure agitation vessel 12 includes a downrigger (not shown) attached to the vessel frame 20 for articulating to engage with solid manure 18 or the bottom of the storage installation 16. The downrigger may provide operation similar to an anchor on a boat. The downrigger may enable the manure agitation vessel 12 to be positioned to increase agitation capabilities without moving the manure agitation vessel 12 away from desired location in the storage installation 16.

During operation of the manure agitation vessel 12 in the storage installation 16, it is also possible for the user 60 to use the downrigger as a tool to help determine whether there is accumulated sludge at the bottom of the storage installation 16 that requires agitation and mixture with the remaining pond liquids. By lowering the downrigger within the storage installation 16, the downrigger extends downward, thus probing the bottom of the storage installation 16 to determine the existence of undue sludge accumulation in the immediate area of the manure agitation vessel 12. If significant accumulation exists, the aft end of the manure agitation vessel 12 will rise due to the downrigger engaging the floor of the storage installation 16, thereby signaling the user 60 of the need to agitate that area of the storage installation 16 more aggressively.

The downrigger may be configured to elevate a portion of the manure agitation vessel 12 relative to an upper surface of the storage installation 16 when sludge build-up is detected at the bottom area of the storage installation 16 being probed.

Referring again to FIG. 1, the manure agitation system 10 advantageously does not locate the heavy fluid pump 34 and prime mover 32 that powers the outlet nozzles 24 on the manure agitation vessel 12, which makes the manure agitation vessel 12 more stable and easier to move. Further, the action of the outlet nozzle 24 agitation may cause the manure agitation vessel 12 to tip, so reducing the weight on the manure agitation vessel 12 may be advantageous.

The remote prime mover 32 provides the input energy to give the manure agitation vessel 12 propulsion and agitation capabilities. The prime mover 32 can easily be exchanged since it is not on the manure agitation vessel 12. As the prime mover 32 is on land, the prime mover 32 is not an integral part of the manure agitation vessel 12. Where different viscosity of manure 18 or where greater flow is needed, the prime mover 32 can be swapped out for a higher power motor 32. The prime mover 32 can be easily replaced to provide more horsepower to the fluid pump 34. Further, if there is a problem with the prime mover 32, the prime mover 32 can be disconnected and removed from the manure agitation system 10. The prime mover 32 can be unplugged or serviced and then be reinstalled in the manure agitation system 10. With the manure agitation system 10, it may be unnecessary for the user 60 to board the manure agitation vessel 12. This eliminates the possibility of the user 60 being exposed to harmful manure gasses, such as carbon dioxide, methane, ammonia, hydrogen sulfide.

In an embodiment, the fluid pump 34 can easily be changed. A larger or smaller fluid pump 34 can be used, simply by connecting the fluid supply conduit 28. If a mechanical failure is encountered at the fluid pump 34, the fluid pump 34 can easily be removed and an alternate source can be used, for example, by changing a tractor or by using an alternate pump.

In contrast, conventional vessels may be limited by the installed input energy source. If the input energy source is not desirable (too big or too small) it cannot easily be changed because it is an integral part of the vessel. Also if the input energy source has a mechanical failure (such as engine failure or pump failure), the vessel is not functional until it is repaired and may be stranded in the manure lagoon.

A further drawback with conventional vessels is the physical size of the units. As the input energy source is located on the vessel, the size and weight of the unit is increased. In order for conventional units to have a floating buoyancy, the conventional units must be a large dimension to accommodate the unit's weight. This size requirement may necessitate additional equipment, such as a large crane, for installing and removing the vessel from the manure storage facilities.

In the present embodiment, having the remote prime mover 32 be land based, the weight of the manure agitation vessel 12 is greatly reduced, and therefore buoyancy can be achieved with a smaller overall dimension of the manure agitation vessel 12. This also means that the manure agitation vessel 12 may be installed and removed from the storage installation 16 without using an expensive crane (depending on the design of the facility). Further, this also facilitates easier transportation of the lighter and smaller manure agitation vessel 12. Further, the smaller manure agitation vessel 12 can also be used in smaller storage installations 16 where a larger vessel would be impractical.

Further, conventional vessels have the intake for the input energy located near or above the spot where the solids are being suspended in the liquid. The input power source then intakes this material that is composed of liquid with saturated solids and reuses it to agitate more solids. This causes rapid wear of the input energy source (pump) and is inefficient because the thick viscosity of the liquid is already saturated. This may cause rapid wear facture with the input energy source. The reason for this is that the floating vessel is positioned in the manure storage facility where there is a large volume of solid material.

In contrast, the input nozzle 38 and prime mover 32 of the present embodiment are remotely located away from the manure agitation vessel 12 at another location of the storage installation 16. The fluid pump 34 pumps liquid that is proximate to the fluid pump 34, which may be predominantly or pure liquid effluent. This provides the input nozzle 38 with liquid that is not heavily saturated. This allows the manure agitation vessel 12 to directly agitate the solids into suspension using unsaturated liquid. The solids will also suspend more efficiently using less input energy with a thinner viscous liquid. Using the predominantly or pure liquid effluent to agitate unsaturated liquid may provide a more efficient pump and reduce pump wear.

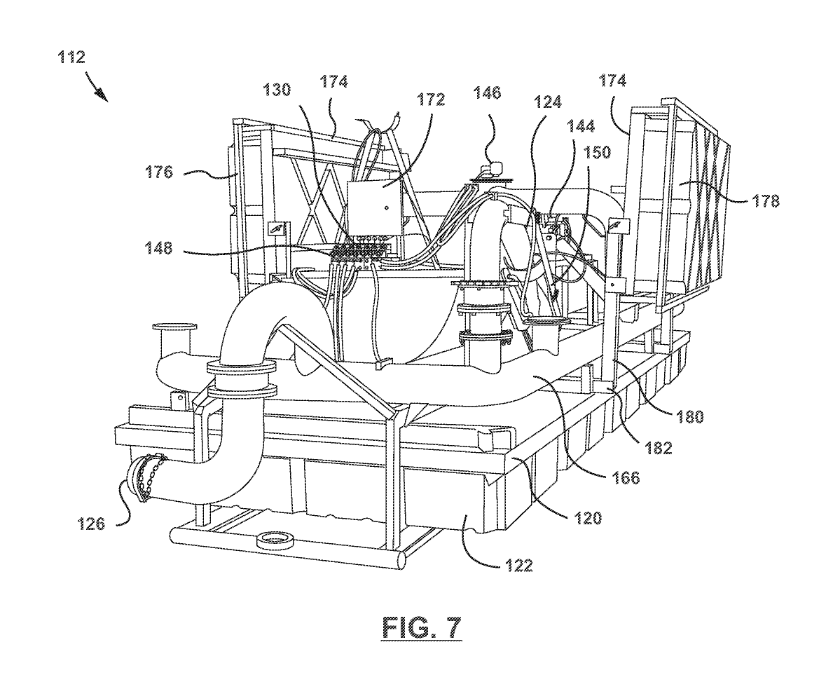

Referring to FIG. 7, illustrated therein is a manure agitation vessel 112, in accordance with a further embodiment. As with the manure agitation vessel 12, described with reference to FIGS. 2 to 6, the manure agitation vessel 112 may be operate in a similar manner and be used in the manure agitation system 10, described with reference to FIG. 1.

The manure agitation vessel 112 includes, a frame 120, floatation 122, and two outlet nozzles 124. The outlet nozzles 124 are each positioned at either end of the manure agitation vessel 112 with piping 166 connecting the two outlet nozzles 124 to an inlet nozzle 126. The outlet nozzle 124 has hydraulic actuators 150 to manipulate the direction of the outlet nozzle 124. The manure agitation vessel 112 includes the control system 130 for controlling the hydraulic actuators 150 and therefore the direction of the outlet nozzle 124. The control system 130 includes an onboard small engine 144 attached to a vessel frame 120 for providing power to a hydraulic pump 146. The hydraulic pump 146 is attached to the vessel frame 120 and pumps hydraulic fluid such as hydraulic oil from a hydraulic fluid reservoir 148 to the hydraulic actuators 150 on the outlet nozzle 124. The control system 130 also includes a control panel 172 that communicates with the remote control 56 (shown schematically in FIG. 1).

The manure agitation vessel 112 includes at least one outrigger 174 on either side of the manure agitation vessel 112 to provide further stability. The outrigger 174 is shown raised for transport or when not in use. The outrigger 174 includes an outrigger frame 176 holding additional flotation 178. The outrigger frame 176 is attached to the vessel frame 120 by an outrigger arm 180 at an outrigger hinge 182.

While the above description provides examples of one or more apparatus, methods, or systems, it will be appreciated that other apparatus, methods, or systems may be within the scope of the claims as interpreted by one of skill in the art.

1. A system for agitating manure comprising:
a vessel shaped to be placed in a manure storage installation, the vessel comprising:
a vessel frame having floatation for providing floatation to the vessel;
at least one outlet nozzle attached to the vessel frame for agitating the manure; and
a control system attached to the vessel frame for controlling the direction of the at least one outlet nozzle;
a land based power source separated from the vessel, wherein the land based power source comprises:
a fluid pump for pumping fluid from a land based input nozzle to supply fluid to the at least one outlet nozzle on the vessel;
a fluid supply conduit connecting the land based power source to the at least one outlet nozzle; and
a remote control for user control of the control system of the vessel.

2. The system of claim 1, wherein the land based power source further comprises:
a prime mover for providing power to the fluid pump;
a fuel tank for storing fuel for the power source; and
a pump control for controlling the fluid pump and the power source.

3. The system of claim 2, wherein the prime mover is exchangeable based on the power needs of the fluid pump without modifying the vessel.

4. The system of claim 1, wherein the land based input nozzle pumps liquid that is located proximate to the land based power source and remote from the vessel.

5. The system of claim 1, wherein the at least one outlet nozzle provides movement to the vessel and the at least one outlet nozzle steers the direction of the vessel.

6. The system of claim 1, wherein the control system comprises:
a hydraulic pump attached to the vessel frame for providing hydraulic fluid to a hydraulic actuator; and
an onboard small engine attached to the vessel frame for providing power to the hydraulic pump;
wherein the hydraulic actuators are attached to the at least one outlet nozzles and manipulate the direction of the at least one outlet nozzles.

7. The system of claim 6, wherein the control system further comprises:
a hydraulic fluid reservoir attached to the vessel frame for storing the hydraulic fluid; and
a fuel tank attached to the vessel frame for storing a fuel supply for the onboard small engine.

8. The system of claim 1, wherein the remote control is operable to control the land based power source.

9. The system of claim 1, wherein the remote control provides control instructions to the control system to control the direction of the outlet nozzles.

10. The system of claim 9, wherein the remote control includes:
a remote transceiver for sending nozzle direction instructions to the control system; and
control inputs for receiving the nozzle direction instructions from a user.

11. The system of claim 10, wherein the control inputs include a set up mode and a run mode.

12. A vessel shaped to be placed in a manure storage installation, the vessel comprising:
a vessel frame having floatation for providing floatation to the vessel;
at least one outlet nozzle attached to the vessel frame for agitating the manure, wherein the at least one outlet nozzle receives fluid from a land based power source via a fluid supply conduit, wherein the land based power source is separated from the vessel; and
a control system attached to the vessel frame for controlling the direction of the at least one outlet nozzle, and wherein the control system receives control instructions from a remote control.

13. The vessel of claim 12, wherein the land based power source is not an integral part of the manure agitation vessel.

14. The vessel of claim 12, wherein the manure agitation vessel further comprises at least one outrigger attached to the vessel frame on either side of the manure agitation vessel to provide further stability to the manure agitation vessel.

15. The vessel of claim 14, wherein the at least one outrigger is hydraulically actuated by an outrigger hydraulic actuator that is controlled by the control system, wherein the outrigger hydraulic actuator hydraulically raises the at least one outrigger for transport and lowers the at least one outrigger when in use.

16. The vessel of claim 15, wherein the at least one outrigger further includes an outrigger frame for holding additional floatation, wherein the outrigger frame is attached to the vessel frame by an outrigger arm at an outrigger hinge.

17. The vessel of claim 12, wherein the at least one nozzle includes two nozzles, each positioned at either end of the vessel.

18. The vessel of claim 12, wherein the manure agitation vessel further comprises a downrigger attached to the vessel frame for articulating to engage with solid manure or the bottom of a storage installation.

19. The vessel of claim 12, wherein the control system comprises:
a hydraulic pump attached to the vessel frame for providing hydraulic fluid to a hydraulic actuator; and
an onboard small engine attached to the vessel frame for providing power to the hydraulic pump;
wherein the hydraulic actuators are attached to the at least one outlet nozzles and manipulate the direction of the at least one outlet nozzles.

20. The vessel of claim 19, wherein the control system further comprises:
a hydraulic fluid reservoir attached to the vessel frame for storing the hydraulic fluid; and
a fuel tank attached to the vessel frame for storing a fuel supply for the onboard small engine.
